(19) United States
(12) Patent Application Publication
(10) Pub. No.: US 2009/0058565 A1
(43) Pub. Date: Mar. 5, 2009

(54) RESONATOR APPARATUS HAVING DIRECT-COUPLED RESONATORS

(76) Inventors: Charles F. Maker, Occidental, CA (US); Curtis Kimble, Rohnert Park, CA (US); Khouzema Unchwaniwala, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/845,741

(22) Filed: Aug. 27, 2007

(51) Int. Cl. H01P 7/00; H01P 1/20

(52) U.S. Cl. 333/219.2; 333/202

(57) ABSTRACT

A resonator apparatus and ferromagnetic resonance filter are described. The apparatuses and filters only include perturbation coils about an input resonator element and an output resonator element.

### BACKGROUND

Resonators are used in a variety of electrical and electronic applications. One type of resonator is a ferromagnetic resonator. A ferromagnetic resonator includes one or more ferromagnetic elements that are immersed in a substantially constant (DC) magnetic field. The magnetic field aligns the magnetic dipoles of the ferromagnetic elements. A radio frequency (RF) signal is then applied at a frequency at or near the resonance frequency of the resonator elements causing a precession of the magnetic dipoles of the ferromagnetic elements at the RF frequency.

Ferromagnetic resonators are often used in electrical filter applications due to their comparatively high resonance frequency, which is typically on the order of GHz. One type of resonator filter includes a number of ferromagnetic elements, with each ferromagnetic element having an input perturbation coil and an output perturbation coil for applying and extracting the RF signal (perturbation signal) to and from the ferromagnetic element. Unfortunately, there are drawbacks to such known arrangements. For example, the task of placing the coils about the individual ferromagnetic element requires precision and is rather tedious. Thus, fabricating such resonators is labor intensive and, in the end, may not provide the filter response desired if the precise location of the coils is not realized. Moreover, at the typically high frequencies of operation, the wires, which make up the coils, can resonate and thereby couple to one another. This results in leaks and poor isolation. Ultimately, among other drawbacks the passband of the filter can shift and develop unwanted ripple.

Another known ferromagnetic filter couples ferromagnetic elements directly, reducing the number of coils. Known direct couple resonator filters are provided in a substantially linear arrangement, either vertically stacked, or arranged horizontally in approximately a line. The vertically arranged resonators require a greater distance between the poles of the magnet (referred to as the pole gap or gap) that supplies the DC magnetic field. As is known, the resonance frequency of the ferromagnetic elements is proportional to the DC magnetic field strength. As such, the desired higher frequencies of operation require a comparatively large magnetic field strength. Attaining such a large field with the increased gap between the poles in a vertical stack resonator filter arrangement necessitates a comparatively large magnet. Among other drawbacks, this results in greater power and space requirements for the overall filter.

When the ferromagnetic elements are arranged in a substantially linear arrangement horizontally, incomplete coupling results, particularly between the interior elements. The resultant phase shift of the RF signal from one ferromagnetic element to the next is not a 90° phase shift. As such, across four elements a complete 360° phase shift is not realized. As a result, rather than providing a substantially uniform response over the passband, the filter response is skewed to an unacceptable degree.

There is a need, therefore, for resonator structure and filter that overcomes at least the shortcoming of known filter designs discussed above.

### SUMMARY

In a representative embodiment, a resonator apparatus comprises a substrate and an input resonator element provided in an input opening in the substrate. The resonator apparatus also comprises an output resonator element provided in an output opening in the substrate and a septum disposed between the input resonator element and the output resonator element. Additionally, the apparatus comprises a first resonator element provided in a first opening in the substrate and directly coupled to the input resonator element; and a second resonator element provided in a second opening in the substrate and directly coupled to the output resonator element. The first and second resonator elements are not coupled to a perturbation coil.

In yet another representative embodiment, a ferromagnetic resonance filter comprises a substrate and an input resonator element provided in an input opening in the substrate. The filter also comprises an output resonator element provided in an output opening in the substrate and a septum disposed between the input resonator element and the output resonator element. Additionally, the filter comprises a first resonator element provided in a first opening in the substrate and directly coupled to the input resonator element; and a second resonator element provided in a second opening in the substrate and directly coupled to the output resonator element. The first and second resonator elements are not coupled to a perturbation coil.

In yet another representative embodiment, a resonator apparatus comprises a substrate and an input resonator element provided in an input opening in the substrate. The apparatus also comprises an output resonator element provided in an output opening in the substrate and a septum disposed between the input resonator element and the output resonator element. Additionally, the apparatus comprises an intermediate resonator element provided in an opening in the substrate and directly coupled to the input resonator element. The intermediate resonator element is not coupled to a perturbation coil.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 is a perspective view of a resonator apparatus in accordance with a representative embodiment.

FIG. 2 is a top view of the resonator apparatus of the representative embodiment of FIG. 1.

FIG. 3 is a cross-sectional view of a resonator apparatus in accordance with a representative embodiment.

FIGS. 4A-4D are graphical representations of passbands of ferromagnetic filters in accordance with representative embodiments.

### DETAILED DESCRIPTION

In the following detailed description, for purposes of explanation and not limitation, representative embodiments disclosing specific details are set forth in order to provide a thorough understanding of the present teachings. Descriptions of known devices, materials and manufacturing methods may be omitted so as to avoid obscuring the description of the example embodiments. Nonetheless, such devices, materials and methods that are within the purview of one of ordinary skill in the art may be used in accordance with the representative embodiments.

The following detailed description includes specific applications of the resonator apparatuses of the representative embodiments in electronic filters and tunable electronic filters. However, filter applications are intended only to be illustrative of the applications of the resonator apparatuses of the present teachings, and other applications are contemplated. For example, the present teachings are also applicable to oscillators, and specifically to multiple-resonator feedback oscillators.

Notably, the filters of the representative embodiments are usefully narrowband filters with applications in a wide variety of applications including receivers, transmitters and transceivers for communications, radar devices and measurement and testing equipment (e.g., spectrum analyzers), to name only a few. As described more fully herein, the filters and resonator apparatuses function at GHz frequencies; illustratively from approximately 1.0 GHz to approximately 60 GHz. It is emphasized that this operational range is merely illustrative and that the resonator apparatuses are contemplated for use outside this range, particularly as magnetic materials of ferromagnetic resonators and magnets evolve.

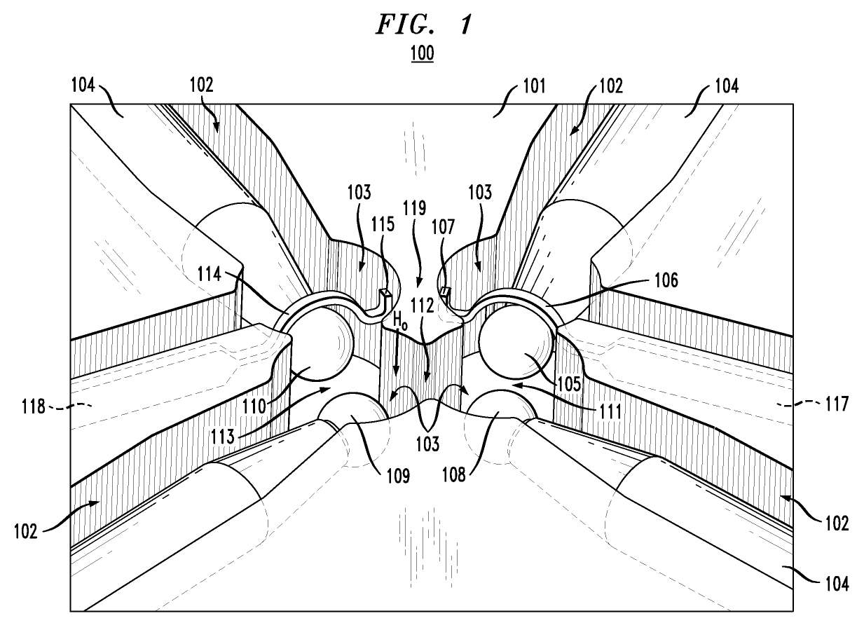

FIG. 1 is a perspective view of a resonator apparatus 100 in accordance with a representative embodiment. The apparatus 100 includes a substrate 101, which is electrically grounded. In a representative embodiment, the substrate 101 comprises a conductive material such as metal or a metal alloy. Alternatively, other conductive materials such as composite materials may be used for the substrate 101. For example, materials such as plated 70-30 Cu—Ni (Cupernic) and certain plated plastics within the purview of one of ordinary skill in the art are contemplated for use as the substrate. As will become more clear as the present description continues, the substrate 101 comprises a material that lends itself to processing to form channels and openings, and provides acceptable electromagnetic isolation to the resonators and other components of the apparatus 100.

The apparatus 100 includes channels 102 that terminate on openings 103. The channels 102 include rods 104, which are illustratively ceramic, and maintain resonator elements suspended in position in respective openings 103. An input resonator element 105 is mounted on a respective rod 104 as shown. An input perturbation coil 106 is disposed over the input resonator element 105 and is electrically grounded to the substrate 101 by ground contact 107. In the present embodiment, the perturbation coil 106 is a half coil, extending about one half or one side of the input resonator element 105. Alternatively, a full coil, which extends completely around the element 105, could be used.

The resonator apparatus 100 includes a first resonator element 108 disposed in a respective opening 103 and positioned and suspended by a respective rod 104. As described more fully herein, the first resonator element 108 couples directly (i.e., without a coil(s) for coupling one resonator element to the next) to the input resonator element 105 via a coupling channel 111 formed in the substrate 101; and does not have a perturbation coil(s) disposed thereabout, thereby providing certain benefits over known resonator structures. A second resonator element 109 is also positioned and suspended in a respective opening 103 by a respective rod 104. The second resonator element 109 is coupled directly to the first resonator element 108 via a coupling channel 112 formed in the substrate; and, like the first resonator element 108, does not have a perturbation coil(s) disposed thereabout.

The resonator apparatus 100 also includes an output resonator element 110 suspended and positioned in a respective opening 103 by a respective rod 104. An output perturbation coil 114 is disposed about the output resonator element 114 and is electrically grounded to the substrate 101 by ground contact 115. Like the input perturbation coil 106, the output resonator coil 114 is a half-coil; although a full coil could be used. The output resonator element 110 couples directly to the second resonator element 109 via a coupling channel 113 formed in the substrate 101. Electromagnetic isolation of the input and output resonators 105, 110, and of their respective coils is provided by a septum 119 formed in the substrate 101 and disposed therebetween.

Illustratively, the resonator elements 105, 108, 109 and 110 comprise single crystal yttrium iron garnet (YIG), which is doped or undoped, and which is ground and polished into a substantially spherical shape. It is noted that the material selection and shape are merely representative. Other ferromagnetic materials, known, yet to be discovered, or yet to be fabricated are contemplated for use as the resonator elements 105, 108, 109 and 110. Moreover, planar ferromagnetic elements, such as disc elements, may be used, although known ferromagnetic discs would be comparatively larger than sphere elements and thus ultimately require larger magnet structures to achieve a uniform DC magnetic field.

In operation, a substantially constant (DC) magnetic (Hₒ) field is applied to the resonator structure by a magnet (not shown in FIG. 1). As is known, the resonance frequency of a spherical YIG resonator element is given by:

ƒₚ=γ(Hₒ±Hₐ)

where Hₒ is the strength of the applied DC field (in Oersteds), Hₐ is the internal anisotropy field in within the YIG material, and γ is the gyromagnetic ratio.

From the above relation, it is appreciated that the resonance frequency of the resonator element is directly proportional to the strength of the applied DC field. Once a desired frequency is selected, the required magnetic field is applied to the apparatus 100 in a direction orthogonal to the top surface of the substrate (shown as Hₒ in FIG. 1). This causes the dipoles of the resonance elements 105, 108, 109 and 110 to align with the field. Next an input signal at or near the selected resonance frequency is provided to the input perturbation coil 106 by an input strip transmission line (stripline) 117. The signal is then applied to the input resonator element 105 by the perturbation coil 106. This causes a precession of the dipoles of the input resonator element 105 at the input frequency.

The input resonator element 105 couples directly to the first resonator element 109 via channel 111, causing dipole precession at the first element 109 at the same frequency, albeit shifted in phase. The process continues with the direct coupling of the first resonator element 109 to the second resonator element 110 via channel 112. Again, the coupling causes the precession of the dipole of the second element 110 at the input (resonance) frequency, again shifted in phase. Finally, the second resonator element 110 couples to the output resonator 110 element via channel 113, causing the dipole precession of the output resonator element 110 at the same frequency. Again, a phase shift occurs.

The output resonator element 110 then couples to the output perturbation coil 114, which provides an output signal to an output stripline 118. Notably, the output signal is shifted in phase by approximately 360° compared to the input signal.

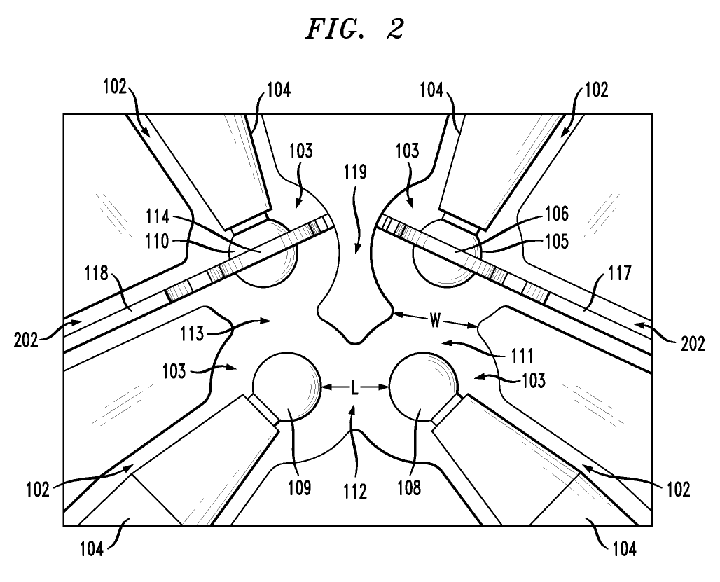

As noted, the input perturbation coil 106 is connected to the input stripline 117, and the output perturbation coil 114 is connected to the output stripline 118. The striplines 117, 118 are maintained in grooves (more readily seen in FIG. 2) in the substrate 101, with air or other dielectric disposed between the center conductor and the walls of the grooves, which function as the ground planes. As shown in FIG. 1, the coils 106, 114 are substantially narrower than the center conductors of respective striplines 117, 118. As such, the striplines 117,118, which are illustratively 50Ω lines, terminate on comparatively high inductance (and impedance) coils 106,114. Usefully, the structure of the striplines 117, 118 and coils 106, 114 of the representative embodiments fosters direct connection of the coils to coaxial connectors via the striplines 117, 118. As shown, the striplines 117, 118 taper to provide an impedance transformation from the comparatively low impedance of the striplines 117,118 to the comparatively high impedance of the perturbation coils 106, 114. Moreover, the striplines 117, 118 may be connected to respective transmission lines (not shown), and the striplines 117, 118 in combination with their respective tapers provide the impedance transformation from the comparatively low impedance of the transmission lines to the comparatively high impedance of the perturbation coils 106, 114. Stated differently, the impedance transformation occurs across the length of the striplines 117, 118. As such, the striplines 117, 118 themselves function as an impedance transformer, or the taper thereon functions as an impedance transformer, or both. Beneficially, the impedance of the striplines 117, 118 can be varied to provide a reduced change in the input and output resonator bandwidth as a function of tuned frequency.

In the presently described embodiment, the resonator apparatus 100 functions as a ferromagnetic resonance filter. Beneficially, the resonator elements are coupled in series and synchronously, which improves passband skirt rolloff of the filter. As such, a comparatively narrow passband with ample roll-off is achieved. Moreover, and as described in greater detail herein, the required field strength is reduced, while tunability of the filter is facilitated and tuning range is increased compared to other known ferromagnetic resonance filters.

FIG. 2 is a top view of the resonator apparatus 100 of the representative embodiment of FIG. 1. Many details of the apparatus 100 are not repeated to avoid obscuring the description of certain features more readily explained via FIG. 2.

As described previously, only the input and output resonators 105, 114 are provided with perturbation coils; whereas first and second resonators 108, 109 couple to respective resonators without a coil (referred to as direct coupling). This provides certain clear benefits over known ferromagnetic resonance filters. Most clear is the benefit of fabrication. As will be readily appreciated, the dimensions of the various components of the apparatus 100 are comparatively small. Moreover, the components are also rather delicate. Thus, the fewer components and connections that are necessary, the less tedious the fabrication and the more robust the final structure. As alluded to previously, in certain known structures full coils are provided over each resonator element. This requires precisely locating the spheres and precisely locating the coils thereabout. As will be appreciated, this increases the complexity of fabrication and thus the cost of the overall device.

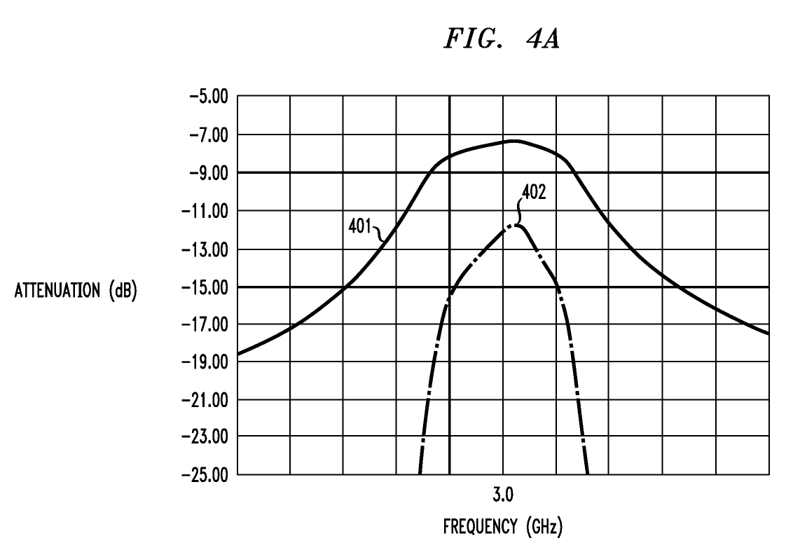

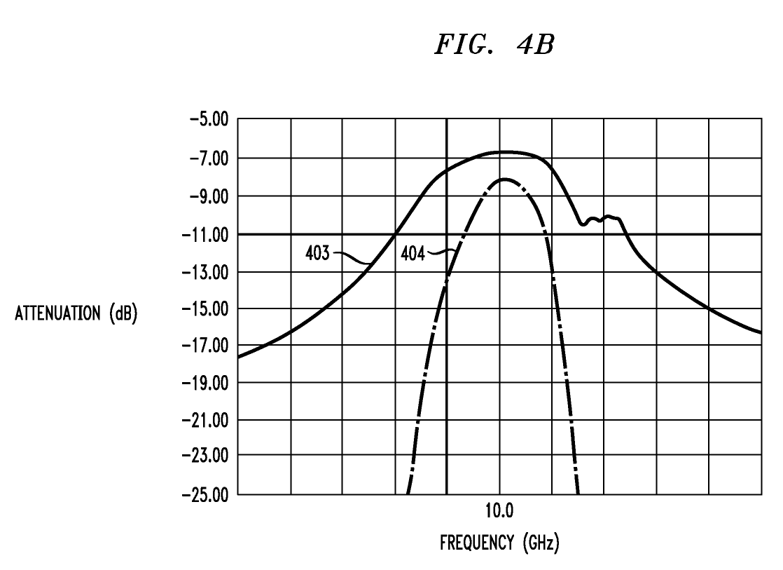

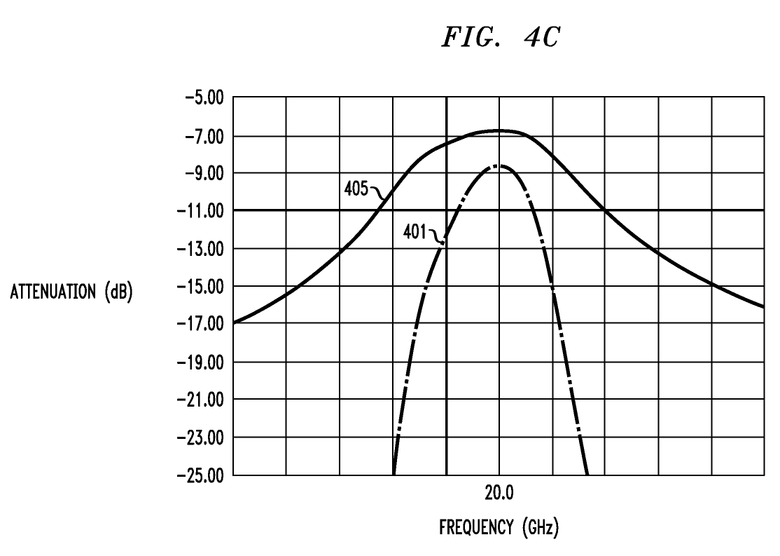

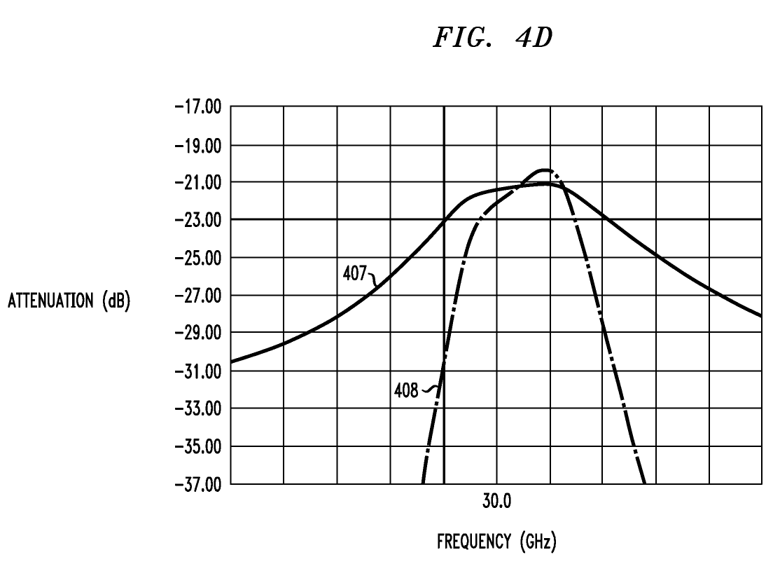

In addition to increased complexity of fabrication, providing coils around each resonator element can degrade performance. To this end, the finite-length wires used for the individual coils can resonate and couple to one another. As such, isolation is compromised and signals can bypass the resonator elements. Ultimately, signal leakage can result and deleteriously impact the performance of the filter. Furthermore, and particularly high frequencies, each wire provided around a resonator increases the reactance of the filter. This results in a skewing, or non-uniformity of the passband shape about the center frequency and over the range of operation. By contrast, and as described in connection with FIGS. 4A-4D, ferromagnetic resonance filters of the representative embodiments provide a comparatively uniform shape over a tuning range of interest. Thus, the filter can be tuned to higher and lower operational frequencies, yet experience insubstantial skewing and ripple degradation of the passband.

The openings 103 provide electromagnetic isolation (isolation) for the resonator elements 105, 108, 109 and 110. In the presently described embodiments, the openings 103 are substantially cylindrically shaped, having walls, which are electrically grounded. As such, the spherical resonator elements 105, 108, 109 and 110 are each disposed in a commensurately shaped opening, which isolates the resonator element from unwanted signals to a beneficial extent. These unwanted signals may result from other resonator elements 113 and from perturbation coils, for example.

The width (‘W’) of the opening of the openings 103 and spacing (‘L’) between the spherical resonators 105, 108, 109 and 110, is selected to maintain isolation, yet provide a conduit for direct coupling. Applicants have experimentally determined that spacing one resonator element from the next (i.e., the distance L) by approximately 1.0 times to approximately 1.5 times the diameter of the spherical resonator element provides suitable isolation between the resonator elements, but allows for proper coupling. Moreover, the width (W) of the opening must be selected to allow coupling to occur, but at the same time, not compromise the isolation of the spherical resonator elements 105, 108, 109 and 110 from spurious signals. Again, Applicants have found experimentally that a width approximately 1.0 to approximately 1.5 times the diameter of the spherical resonator element allows for direct coupling while acceptably maintaining isolation of the resonator elements.

Isolation between the input resonator element 105 and input perturbation coil 106, and between the output resonator element 110 and output perturbation coil 114 is provided substantially by the septum 119. The septum 119 has a length sufficient to extend between the input resonator element 105 and input perturbation coil 106, and the output resonator element 110 and output perturbation coil 114, but allow for a sufficient width for channel 112 to foster direct coupling between the first and second resonator elements 108 and 109. Moreover, the septum 119 has a width sufficient to extend between the input resonator element 105 and input perturbation coil 106, and the output resonator element 110 and output perturbation coil 114; but allows for a sufficient width for channel 111 and for channel 113 to foster direct coupling between the respective resonator elements.

Furthermore, the channels 111, 112, 113 and openings 103 are provided in a substantially non-linear arrangement, which fosters direct coupling between adjacent resonator elements and isolation from non-adjacent elements. In representative embodiments, the channels 111-113 and the openings 103 are provided so that input resonator element 105, the output resonator element 110, the first resonator element 108 and the second resonator element 109 are in a polygonal arrangement. This polygonal arrangement may be substantially a square, or substantially a rectangle (i.e., having substantially 90° angles between the channels). However other shaped arrangements between the channels are contemplated.

In the representative embodiments described to this point, four resonator elements are provided to realize a 360° phase shift from input to output are described. While the four resonator arrangement is beneficial, embodiments with more or fewer resonator elements are also contemplated. Notably, the basic teachings of the resonator structure, arrangement of components and considerations described to this point apply, with certain variations.

A resonator apparatus according to a representative embodiment having three resonator elements is arranged as in FIGS. 1 and 2, excepting the output resonator element 110 is foregone. As such, the cavity 103 in which the element 110 is provided is foregone; as is the channel 113, the rod 104 on which the element 110 is disposed, and its channel 102. Moreover, channel 202 and stripline 118 are not located as shown. Rather, the first resonator element 108 becomes the intermediate resonator element and the second resonator element 109 becomes the output resonator element. The output perturbation coil 114 is disposed about output resonator element 109. The channel 202 and the stripline 118 are arranged to couple to the element 109. Such a structure provides a phase shift of the input signal of approximately 270°, which is suitable for certain applications. As will be appreciated, in a filter application, the passband roll-off may be comparatively less steep than a four element apparatus such as shown in FIGS. 1 and 2.

Moreover, more than four resonators may be provided in an arrangement such as somewhat of a chorded arc. This structure may be useful to accommodate for deficiencies in coupling as well as spurious resonances in practical applications. Again, the basic structure of the resonator apparatus described in connection with FIGS. 1 and 2 applies. For example, only the input and output perturbation coils are provided; and the resonator elements are provided in cavities with channels for coupling therebetween.

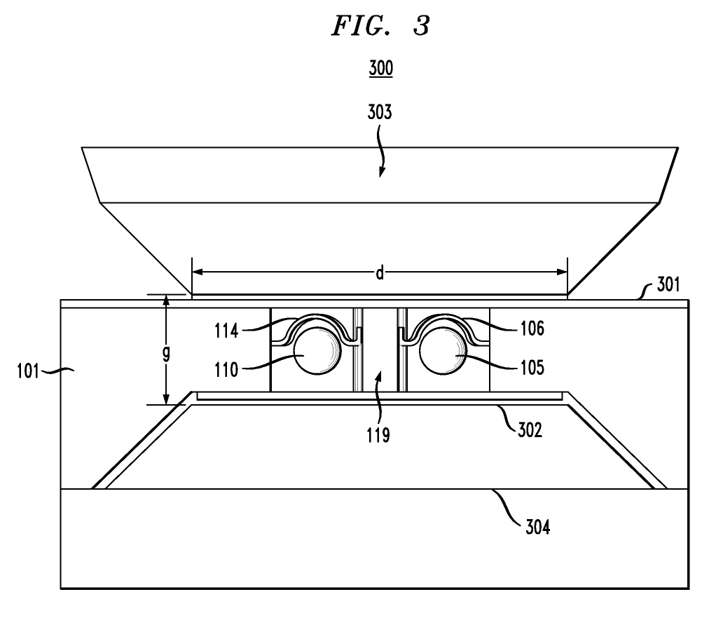

FIG. 3 is a cross-sectional view of a resonator apparatus 300 in accordance with a representative embodiment. Many details of the apparatus 100 described in connection with FIGS. 1 and 2 are not repeated to avoid obscuring the description of certain features more readily explained via FIG. 3.

The resonator apparatus 300 includes an upper ground plane 301 and a lower ground plane 302. The ground planes 301, 302 are disposed over and beneath the substrate 101, respectively. As will be appreciated, the ground planes function to further improve the isolation of the resonator elements 105, 108, 109, 110, and other electrical components, such as the coils 106, 114. Moreover, the ground planes 301, 302 may function as ground planes for signal transmission lines, such as coils 106,114 with air comprising the dielectric of the transmission line. In representative embodiments, the ground planes 301, 302 comprise a metal, metal alloy or conductive composite material similar or identical to the material of the substrate 101.

The resonator apparatus 300 also includes a first magnetic pole 303 and a second magnetic pole 304. The poles 303, 304 provide the magnetic field, Hₒ, having a desired field strength and uniformity. As noted, the field strength is selected to effect a desired resonance frequency of the resonator elements 105, 108, 109, 110 of the resonator apparatus. The field uniformity is needed to provide to effect proper orientation of the dipoles of the resonator elements.

As alluded to previously, the resonance apparatuses 100, 300 of the representative embodiments facilitate comparatively small magnet pole face diameters (‘d’ in FIG. 3) and pole gap (‘g’ in FIG. 3). As to the former, certain known ferromagnetic resonator devices may require a comparatively large pole face diameter. For example, a device having a substantially linear arrangement of resonator elements will require a greater pole face diameter. Ultimately, this requires greater electrical power to attain the desired magnetic field strength and field uniformity.

As to the latter, the structure of the apparatuses 100, 300 lends itself to reducing the gap between the poles 303, 304. For example, unlike known vertically aligned resonator elements require a comparatively large pole gap. As the field strength varies with the inverse of the gap, a comparatively large power magnet is needed in such known devices. Moreover, regardless of the arrangement of the resonator elements, many known devices include full perturbation coils. In certain representative embodiments, half-coils are used, with the upper (or lower) ground plane 303 (304) functioning as the ground plane of the perturbation coils. Thereby, room is not needed for coils on both sides of the resonator elements, and the poles can be brought in closer proximity. Thus, the gap is reduced.

In a representative embodiment, the pole face diameter (d) is approximately 300 mils and the gap (g) is approximately 20 mils. Moreover, known Ni—Fe magnets may be used to effect the tuning of the filter over a particular frequency range. In certain embodiments, Co—Fe inserts are provided in the Ni—Fe magnet to achieve a greater magnetic field strength; illustratively approximately 24 kGauss. Certain benefits in performance are also realized. For example, because the gap is comparatively small, a greater magnetic field is more easily attained. This allows tuning of the filter over a greater range. Illustratively, a ferromagnetic resonance filter comprising the resonator apparatus 300 can be tuned over a range of approximately 2.0 GHz to approximately 67.0 GHz by tuning the magnetic field strength between poles 303, 304 to the needed value for resonance. Moreover, because the requirements on the magnet are comparatively reduced, the power required to attain the illustrative tuning range is approximately 1.6 W.

In addition to an improved tuning range and reduced power requirements of the magnet, ferromagnetic resonance filters comprising resonator apparatuses 100, 300 also provide more uniformity over a passband of interest and a tuning range. As described previously, this is attributed to greater coupling between resonator elements 105, 108, 109, 110, and greater isolation across the apparatuses 100, 300. FIGS. 4A-4D illustrate the tuning range and uniformity of a ferromagnetic resonator filter of a representative embodiment. From a review of these graphs, one skilled in the art will appreciate that the 3 dB Bandwidth of the resonance is maintained at substantially 20 Mhz when the center frequency is tuned from approximately 4.0 GHz to approximately 30 GHz.

FIG. 4A shows a filter tuned to a center frequency of 4.0 GHz. Curve 401 shows the passband at 2 dB per division and curve 402 shows the passband at 10 dB per division. As will be appreciated from a review of FIG. 4A, there is comparatively small skewing of the curves; with substantial symmetry about the center (resonance) frequency.

FIG. 4B shows a filter tuned to a center frequency of 10 GHz. Curve 403 shows the passband at 2 dB per division and curve 404 shows the passband at 10 dB per division. As will be appreciated from a review of FIG. 4B, there is comparatively small skewing of the curves; with substantial symmetry about the center (resonance) frequency. Moreover, there is little change in the passband shapes of FIGS. 4A and 4B.

FIG. 4C shows a filter tuned to a center frequency of 20 GHz. Curve 405 shows the passband at 2 dB per division and curve 406 shows the passband at 10 dB per division. As will be appreciated from a review of FIG. 4C, there is comparatively small skewing of the curves; with substantial symmetry about the center (resonance) frequency. Moreover, there is little change in the passband shapes of FIGS. 4A and 4C.

FIG. 4D shows a filter tuned to a center frequency of 30 GHz. Curve 407 shows the passband at 2 dB per division and curve 408 shows the passband at 10 dB per division. As will be appreciated from a review of FIG. 4D, there is comparatively small skewing of the curves; with substantial symmetry about the center (resonance) frequency. Moreover, there is little change in the passband shapes of FIGS. 4A and 4B.

In view of this disclosure it is noted that the various resonator apparatuses and ferromagnetic resonance filters described herein can be implemented in a variety of materials and variant structures. Moreover, applications other than ferromagnetic resonance filters may benefit from the present teachings. Further, the various materials, structures and parameters are included by way of example only and not in any limiting sense. In view of this disclosure, those skilled in the art can implement the present teachings in determining their own applications and needed materials and equipment to implement these applications, while remaining within the scope of the appended claims.

1. A resonator apparatus, comprising:
a substrate;
an input resonator element provided in an input opening in the substrate;
an output resonator element provided in an output opening in the substrate;
a septum disposed between the input resonator element and the output resonator element;
a first resonator element provided in a first opening in the substrate and directly coupled to the input resonator element; and
a second resonator element provided in a second opening in the substrate and directly coupled to the output resonator element, wherein the first and second resonator elements are not coupled to a perturbation coil.

2. A resonator apparatus as claimed in claim 1, wherein the input resonator element, the output resonator element, the first resonator element and the second resonator element are each ferromagnetic resonator elements.

3. A resonator apparatus as claimed in claim 2, wherein the ferromagnetic resonator elements comprise yttrium iron garnet (YIG).

4. A resonator apparatus as claimed in claim 2, wherein the ferromagnetic resonator elements are substantially spherical.

5. A resonator apparatus as claimed in claim 1, further comprising an input perturbation coil disposed about the input resonator element and an output perturbation coil disposed about the output resonator element.

6. A resonator apparatus as claimed in claim 1, wherein the input resonator element, the output resonator element, the first resonator element and the second resonator element are provided in a substantially non-linear arrangement.

7. A resonator apparatus as claimed in claim 1, wherein the substrate further comprises:
a first channel between the input resonator element and the first resonator element;
a second channel between the first resonator element and the second resonator element; and
a third channel between the second resonator element and the output resonator element.

8. A resonator apparatus as claimed in claim 1, wherein the septum is electrically grounded and provides isolation between the input resonator element and the output resonator element.

9. A resonator apparatus as claimed in claim 1, wherein: the resonator elements are substantially spherical in shape, and the openings extend through the substrate and have a width of approximately 1.0 times to approximately 1.5 times a diameter of the resonator elements.

10. A resonator apparatus as claimed in claim 5, wherein the input perturbation coil is coupled to an input transmission line having an input impedance and an impedance transformer transforms the impedance from the input impedance to an input impedance of the input perturbation coil.

11. A ferromagnetic resonator filter, comprising:
a substrate;
an input resonator element provided in an input opening in the substrate;
an output resonator element provided in an output opening in the substrate;
a septum disposed between the input resonator element and the output resonator element;
a first resonator element provided in a first opening in the substrate and directly coupled to the input resonator element; and
a second resonator element provided in a second opening in the substrate and directly coupled to the output resonator element, wherein the first and second resonator elements are not coupled to a perturbation coil.

12. A filter as claimed in claim 11, wherein the input resonator element, the output resonator element, the first resonator element and the second resonator element are each ferromagnetic resonator elements.

13. A filter as claimed in claim 12, wherein the ferromagnetic resonator elements comprise yttrium iron garnet (YIG).

14. A resonator apparatus as claimed in claim 12, wherein the ferromagnetic resonator elements are substantially spherical.

15. A resonator apparatus as claimed in claim 11, further comprising an input perturbation coil disposed about the input resonator element and an output perturbation coil disposed about the output resonator element.

16. A resonator apparatus as claimed in claim 11, wherein the input resonator element, the output resonator element, the first resonator element and the second resonator element are provided in a substantially non-linear arrangement.

17. A resonator apparatus as claimed in claim 11, wherein the substrate further comprises:
a first channel between the input resonator element and the first resonator element;
a second channel between the first resonator element and the second resonator element; and
a third channel between the second resonator element and the output resonator element.

18. A resonator apparatus as claimed in claim 11, wherein an input signal undergoes a phase shift of approximately 360° between the input resonator element and the output resonator element.

19. A resonator apparatus as claimed in claim 11, wherein the septum is electrically grounded and provides isolation between the input resonator element and the output resonator element.

20. A resonator apparatus as claimed in claim 11, wherein: the resonator elements are substantially spherical in shape, and the openings extend through the substrate and have a width of approximately 1.0 times to approximately 1.5 times a diameter of the resonator elements.

21. A resonator apparatus, comprising:
a substrate;
an input resonator element provided in an input opening in the substrate;
an output resonator element provided in an output opening in the substrate;
a septum disposed between the input resonator element and the output resonator element; and
an intermediate resonator element provided in an opening in the substrate and directly coupled to the input resonator element, wherein the intermediate resonator element is not coupled to a perturbation coil.

22. A resonator apparatus as claimed in claim 21, wherein the input resonator element, the output resonator element and the intermediate resonator element are each ferromagnetic resonator elements.

23. A resonator apparatus as claimed in claim 22, wherein the ferromagnetic resonator elements comprise yttrium iron garnet (YIG).

24. A resonator apparatus as claimed in claim 21, further comprising an input perturbation coil disposed about the input resonator element and an output perturbation coil disposed about the output resonator element.

25. A resonator apparatus as claimed in claim 21, wherein the resonator apparatus is a ferromagnetic resonance filter.
